(19) United States
(12) Patent Application Publication
(10) Pub. No.: US 2002/0010659 A1
(43) Pub. Date: Jan. 24, 2002

(54) Inventory management and/or control

(76) Inventors: David Cruse, Lexington, KY (US); Karl Kuhn, Lexington, KY (US); Sarah Sandknop, Versailles, KY (US)

Correspondence Address: J. Kevin Gray, Jenkens & Gilchrist, P.C., 3200 Fountain Place, 1445 Ross Avenue, Dallas, TX, 75202-2799, US

(21) Appl. No.: 09/846,105

(22) Filed: Apr. 30, 2001

Related U.S. Application Data
(60) Provisional application No. 60/200,631, filed on Apr. 28, 2000.

(51) Int. Cl. G06F 17/60

(52) U.S. Cl. 705/28

(57) ABSTRACT

Methods, systems, and arrangements enable point of use replenishment coupled with available centralized oversight. In accordance with certain embodiment(s), when inventory reaches a pre-set level, a code representative of the particular stock is input into a device. The device may be used to forward the code to a central database repository. From the central database repository, a purchase order may be sent to a pre-identified supplier. The supplier may thereafter ship the stock directly to the point of use, where a receipt and/or a code indicative of the new stock may be entered into the system (e.g., using the device). A centralized authority may be granted access to the central database repository to enable review, modification, configuration, etc. of all or a part of the total inventory situation. Notably, any or all of the transmissions and communications may be effectuated using the Internet and/or an Internet browser.

### BACKGROUND OF THE INVENTION

1. Technical Field of the Invention

The present invention relates in general to the field of inventory management and/or control, and in particular, by way of example but not limitation, to a point of use replenishment system facilitated by world wide web (WWW)-enabled communication to enhance inventory acquisition, disbursement, oversight, and overall organization.

2. Description of Related Art

Successful companies have long placed a premium on management and control of the various inventories used in the course of their enterprises. Initially, this consisted of periodically manually counting supplies and attempting to reorder new supplies for delivery prior to completely depleting them. Gradually, companies began to keep manual records of inventory inflows and outflows so as to keep a running total that indicated a current level of inventory. This reduced the frequency of manual counting to re-determine inventory levels. More importantly, it gave companies a better chance to reorder and restock supplies before their complete depletion.

As companies grew in size and expanded geographically, inventories became distributed and the managerial responsibility for maintaining proper levels of inventory became likewise dispersed. Consequently, company-wide coordination of inventory control suffered. First, manual counting and/or logging of inventory tends to be replete with inaccuracies. Second, the manually-attained results must then be forwarded to a centralized corporate processing facility for manual amalgamation and analysis of the data. This step introduces still further errors and logistical difficulties. Third, the results of the analysis must be transformed into a series of orders that must be manually sent to a multitude of suppliers. Fourth, once the supplies have been delivered to the central processing facility, they must be divided according to need and disbursed among the geographically separated locations needing the respective supplies or portions thereof.

Companies eventually realized that exceptional management and control of inventories provided a competitive advantage and could add to the bottom line. Minimizing the underutilization of capital as embodied by the existence of physical inventory became an overriding goal for those charged with reducing the drain on profits caused by unnecessary inventories. In fact, industry created the term “turn”, which is defined to be the number of times inventory is completely depleted (and correspondingly restocked) during a given period of time. In other words, the higher the frequency of “turn over” of an inventory the better. Furthermore, as the period of time required to turn over one's inventory approaches zero, “just-in-time (JIT) delivery” and management control is achieved.

While JIT strategies minimize the cost of inventory, implementing such strategies are not without risks. For example, even if arrangements with suppliers are tightly controlled, any unpredictable delays can result in idle workers and/or infrastructure, along with a resulting inability to meet customers' demands and expectations. Having a certain minimum level of inventory at all times is therefore often preferable. Holding too much inventory, on the other hand, can result in other costs beyond the mere idling of investment capital. These costs may include, for example, holding onto inventory that is no longer needed or desired by the marketplace or having significant quantities of inventory that suffer or suffers from an unexpected loss in value or an almost certain decrease in value over time, as is common in many high technology areas.

Top-notch inventory management and control therefore involves a delicate balance between having too much inventory on average, which squanders resources and risks capital depreciation, and running out of inventory, which may result in missed opportunities and/or damaged customer relations. Moreover, this delicate balance must be achieved while coordinating the ordering of inventory from a multitude of suppliers and the delivery of the inventory to various geographically-dispersed operating locations.

### SUMMARY OF THE INVENTION

The deficiencies of the prior art are overcome by the methods, systems, and arrangements of the present invention. For example, as heretofore unrecognized, it would be beneficial if remote sites, a central facility, multiple vendors, etc. were linked into a seamless electronic inventory management and/or control scheme. In fact, it would be beneficial if this seamless electronic inventory management and/or control scheme utilized a network accessible by the remote sites, the central facility, the multiple vendors, etc., such as a graphics-based portion of an inter-working network (e.g., the WWW portion of the Internet).

Methods, systems, and arrangements enable point of use replenishment coupled with available centralized oversight. In accordance with certain embodiment(s), when inventory reaches a pre-set level, a code representative of the particular stock is input into a device. The device may be used to forward the code to a central database repository. From the central database repository, a purchase order may be sent to a pre-identified supplier. The supplier may thereafter ship the stock directly to the point of use, where a receipt and/or a code indicative of the new stock may be entered into the system (e.g., using the device). A centralized authority may be granted access to the central database repository to enable review, modification, configuration, etc. of all or a part of the total inventory situation. Notably, none, any, or all of the transmissions and communications may be effectuated using the Internet and/or an Internet browser.

The above-described and other features of the present invention are explained in detail hereinafter with reference to the illustrative examples shown in the accompanying drawings. Those skilled in the art will appreciate that the described embodiments are provided for purposes of illustration and understanding and that numerous equivalent embodiments are contemplated herein.

### BRIEF DESCRIPTION OF THE DRAWINGS

A more complete understanding of the methods, systems, and arrangements of the present invention may be had by reference to the following detailed description when taken in conjunction with the accompanying drawings wherein:

FIG. 1 illustrates an exemplary seamless electronic inventory management and/or control scheme in accordance with the present invention;

FIG. 2 illustrates an exemplary embodiment of an exemplary seamless electronic inventory management and/or control scheme in accordance with the present invention;

FIG. 3A illustrates an exemplary order flow in accordance with the present invention;

FIG. 3B illustrates an exemplary line replenishment in accordance with the present invention;

FIG. 4 illustrates an exemplary order process in accordance with the present invention;

FIGS. 5A-5K illustrate exemplary aspects of exemplary inventory software in accordance with the present invention;

FIG. 6 illustrates a portion of an exemplary point of use replenishment system in which at least part thereof is realized using a web-based scheme in accordance with the present invention;

FIG. 7 illustrates another portion of an exemplary point of use replenishment system in which at least part thereof is realized using a web-based scheme in accordance with the present invention;

FIG. 8 illustrates yet another portion of an exemplary point of use replenishment system in which at least part thereof is realized using a web-based scheme in accordance with the present invention;

FIG. 9 illustrates an exemplary point of use replenishment system in which at least part thereof is realized using the Internet in accordance with the present invention; and

FIGS. 10A-10G illustrate additional exemplary aspects of exemplary inventory software in accordance with the present invention.

### DETAILED DESCRIPTION OF THE DRAWINGS

In the following description, for purposes of explanation and not limitation, specific details are set forth, such as particular circuits, logic modules (implemented in, for example, software, hardware, firmware, some combination thereof, etc.), techniques, etc. in order to provide a thorough understanding of the invention. However, it will be apparent to one of ordinary skill in the art that the present invention may be practiced in other embodiments that depart from these specific details. In other instances, detailed descriptions of well-known methods, devices, logical code (e.g., hardware, software, firmware, etc.), etc. are omitted so as not to obscure the description of the present invention with unnecessary detail.

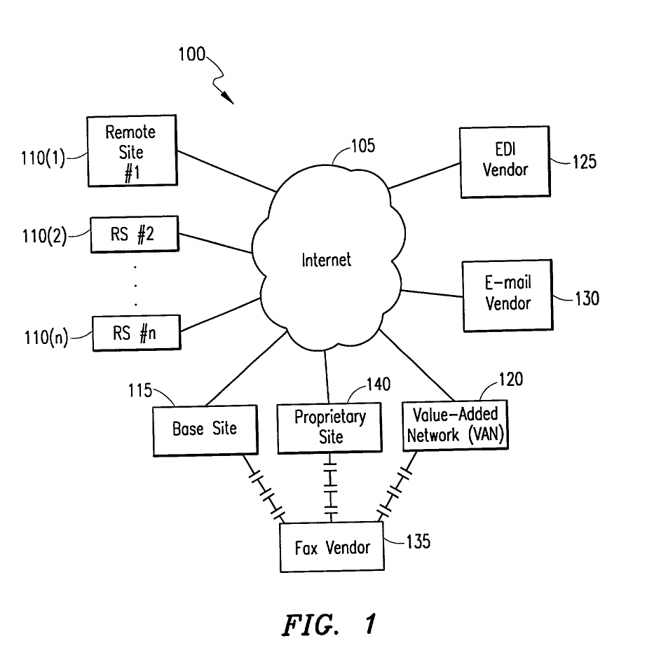

A preferred embodiment of the present invention and its advantages are best understood by referring to FIGS. 1-10G of the drawings, like numerals being used for like and corresponding parts of the various drawings.

Referring now to FIG. 1, an exemplary seamless electronic inventory management and/or control scheme in accordance with the present invention is illustrated generally at 100. An Internet 105 is illustrated connecting various entities. A remote site #1 110(1) is capable of communicating via the Internet 105. It should be understood that more than a single remote site #1 110(1) may be part of the inventive inventory management and/or control scheme, as indicated by the illustrated remote site #2 110(2) . . . remote site #n 110(n), which may be geographically dispersed. The remote sites 110(n) may correspond to, for example, geographically-dispersed locations requiring inventory for the execution of their assigned functions. A base site 115 is also illustrated as being capable of communicating via the Internet 105, with the base site corresponding to, for example, a centralized inventory oversight facility.

A value-added network (VAN) 120 is illustrated as being able to communicate over the Internet 105. The exemplary seamless electronic inventory management and/or control scheme 100 may also include an electronic data interchange (EDI) vendor 125, an e-mail vendor 130, and a fax vendor 135. (EDI may refer to any general or specific electronic format for communicating between entities in, for example, a busines-to-business (B2B) environment.) The EDI vendor 125, the e-mail vendor 130, and the fax vendor 135 may receive (and optionally respond to) orders via the Internet 105, the Internet 105, and fax machines (not explicitly shown in FIG. 1), respectively. It should be noted that the fax vendor 135 is shown as being capable of communicating with the base site 115 and the VAN 120 over telephone wires. It should be understood that there may be multiple equivalent entities for at least the EDI vendor 125, the e-mail vendor 130, and the fax vendor 135, despite that no such multiple equivalent entities are specifically shown in FIG. 1.

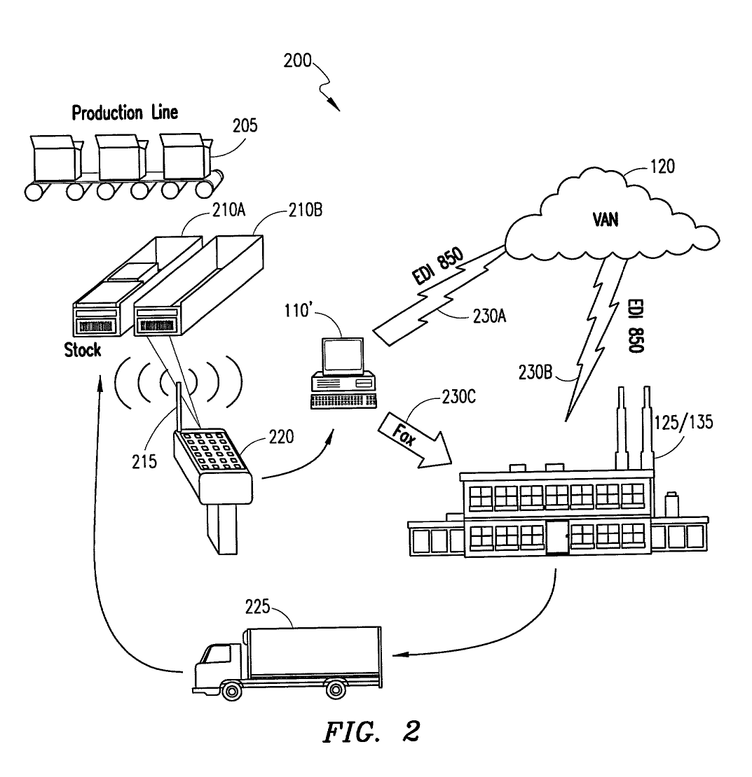

Referring now to FIG. 2, an exemplary embodiment of an exemplary seamless electronic inventory management and/or control scheme in accordance with the present invention is illustrated generally at 200. If a remote site 110 (as illustrated in FIG. 1) is charged with the function of producing a good, then the production line 205 uses (e.g., gradually depletes) the inventory 210 (e.g., stock on hand) In this embodiment, the inventory 210 is divided into two portions. While a first portion is being used, the second portion is held in reserve. Once the first portion is exhausted, the second portion of the inventory 210 may be utilized to meet the needs of the production line 210. In accordance with certain embodiment(s), when the first portion 210B is fully depleted, the reorder process is set into motion. In this manner, while the first portion 210B is being replenished, the second portion 210A is relied on for inventory. Under this regime, if the inventory is divided into only two portions, then each portion 210A/B preferably can supply the production line 205 with necessary inventory for as long as it takes for the other portion 210B/A to be replenished (e.g., using principles in accordance with certain embodiment(s) of the present invention). It should be noted that this approach to inventory management is sometimes termed “two-bin/kanban”.

In the embodiment of 200, a handheld scanner 220 may be used to scan a bar code (which may be placed on/with/etc. each portion 210A/B) associated with a portion of the inventory 210 that has been depleted. It should be noted that the handheld scanner 220 may alternatively be any general-purpose input device capable of receiving and storing information related to inventory types, levels, etc. (e.g., the inventory-related information may be entered into the scanner using a short range radio frequency (RF) link (e.g., using a Bluetooth unit), an infrared link, etc.). The handheld scanner 220 may include wireless interfaces 215 such as a bar code scanner and RF link. Once the bar code information has been entered into the handheld scanner 220, the bar code information may be forwarded to an inventory computer 110′, which may be associated with the remote site #1 110(1) (as illustrated in FIG. 1). The bar code information may be communicated to the inventory computer 110′ using the RF link, a physical docking bay, etc. The inventory computer 110′ may be, for example, a relatively simply device with the ability to access the Internet (e.g., a “net computer” with handheld scanner interface ability), an ordinary personal computer (PC), a workstation, etc. The inventory computer 110′ may be running, for example, a relatively-thin client such as a “browser”-type software program for interfacing with the WWW.

The inventory computer 110′ may send a request for reorder (e.g., of inventory portion 210B) using an EDI 850 order 230A to the VAN 120 or using a fax 230C order to the vendor 125/135. If the VAN 120 is utilized, then the VAN 120 may send an EDI 850 order 230B to the same or a different vendor 125/135. It should be noted (i) that at least the two EDI 850 orders 230A and 230B may be communicated via the Internet 105 and (ii) that the inventory computer 110′ may alternatively send the EDI 850 order 230A directly to the vendor 125/135, thus bypassing the VAN 120. Once the vendor 125/135 receives and process an order, a shipment 225 may be sent to replenish the inventory 210, specifically the first inventory portion 210B that was fully depleted and subsequently entered into the reorder process.

The exemplary point of use replenishment system described herein may be advantageously implemented using a network to which most or all the relevant entities have access. In other words, remote production line sites, various vendors, any centralized management/oversight location(s), VAN participants, etc. may be able to communicate and/or share information over a network using substantially similar and/or compatible and/or translatable protocols. Facilitating software may be PC-based, including a relatively-thin client such as browser. Certain embodiment(s) of the inventive point of use replenishment system, methods, etc. automate the purchasing process to decrease average inventory levels, cut purchasing costs, and reduce paperwork. Implementation of the present invention, in one or more but not necessarily all embodiments, realizes one or more of the following benefits: increased turns; reduced inventory (e.g., inventory can be managed at the point of use, duplicate buffers can be eliminated, etc.); reduced procurement costs (e.g., replenishment can be triggered by line personnel, paperwork can be reduced, quality can be increased through EDI and bar coding or similar); reduced cycle time; enhanced flexibility; etc.

As discussed or at least alluded to hereinabove with reference to FIGS. 1 and 2, certain embodiment(s) in accordance with the present invention may entail one or more of the following exemplary attributes: a two-bin/kanban inventory system; empty bin triggering of replenishment; bar code or similar scanning or otherwise detecting to identify order and location; sending of EDI and/or fax purchase orders to suppliers; acknowledgment by suppliers of orders received and/or shipped; product/stock scanned or otherwise entered into inventory system upon receipt (e.g., at remote site 110(1)); received product/stock is routed to point of use (e.g., at inventory 210 area near production line 205); etc.

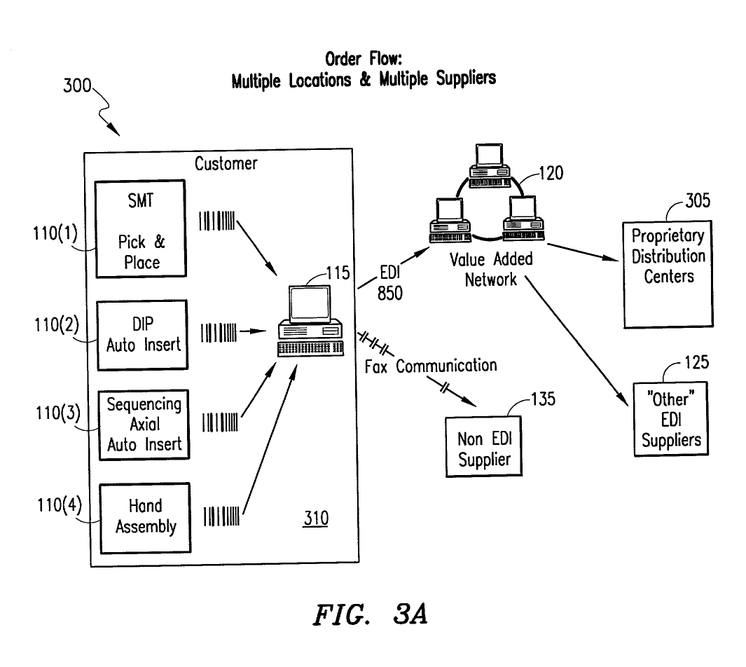

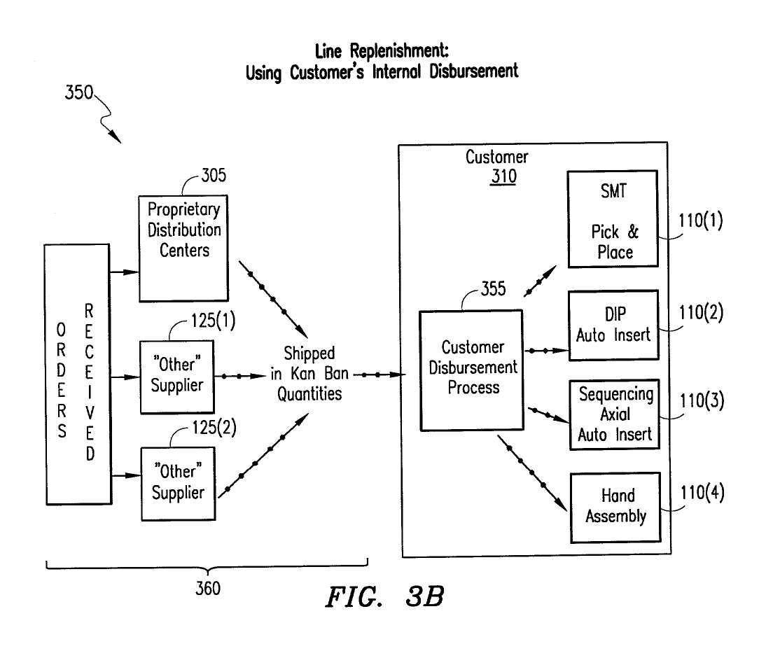

Referring now to FIG. 3A, an exemplary order flow in accordance with the present invention is illustrated generally at 300. The order flow diagram 300 addresses an exemplary situation in which there are multiple remote site locations and multiple suppliers. For the customer 310, there are illustrated multiple remote sites 110(1, 2, 3, 4), each with a particular stock and an associated bar code. When a (e.g., kanban) portion is depleted, the bar code may be scanned and transmitted from the respective remote site 110 and sent (e.g., over the Internet 105 (of FIG. 1) as indicated by the solid arrows) to the base site 115. The transmission may be a completed order ready for forwarding, a “mere” parts identification and quantity for combining with other requests from other remote sites at the base site 115, etc. The base site 115 may send an EDI 850 order to the VAN 120 via, for example, the Internet 105 as indicated by the solid arrow.

Alternatively, the base site 115 may send a fax communication (e.g., over telephone lines as indicated by the broken and crossed arrow) to a non-EDI/fax supplier 135. If the base site 115 elected to send the EDI 850 order to the VAN 120, then the VAN 120 may forward (e.g., with or without combining with other orders) an EDI order to a proprietary distribution center 305, a different EDI supplier or suppliers 125, etc. It should be noted that the base site 115 may also (instead of or in addition to) send an EDI order directly to the proprietary distribution center 305, the different EDI supplier 125, etc. These orders or other communication(s) may also be advantageously transmitted over a network to which the entities have access, such as the Internet 105 (e.g., as indicated by the solid arrows in the order flow diagram 300). It should be understood that the proprietor of the proprietary distribution center 305 may be the same or related to the proprietor of the relevant point of use replenishment system, including any software therefor.

Referring now to FIG. 3B illustrates an exemplary line replenishment in accordance with the present invention is illustrated generally at 350. The line replenishment diagram 350 addresses an exemplary situation in which the customer's internal disbursement procedures 355 are utilized. For the customer 310, there are illustrated multiple remote sites 110(1, 2, 3, 4), each with a particular inventory need. Once the orders are received at the respective supplier(s) 125(1, 2) and/or distribution center 305, the ordered stock may be shipped (e.g., in kan ban quantities) (as represented by the bracketed 360) to a site/location stipulated by the customer's internal disbursement procedures 355. This may be separate (e.g., regional or fully centralized) facilities (or facility) or directly to the designated remote site 110(1, 2, 3, 4) of ultimate use.

It should be noted that in the line replenishment diagram 350, while the solid arrows may continue to indicate an exemplary communication via the Internet 105, the solid dotted arrows indicate the physical movement of ordered product. It should also be noted that for both the order flow diagram 300 and the line replenishment diagram 350, in alternative embodiment(s), the elements indicated by the reference numbers “110(1, 2, 3, 4)” and “115” may alternatively correspond to different inventory stock piles (e.g., 210(1, 2, 3, 4) of FIG. 2) and an inventory computer (e.g., 110′ of FIG. 2). Thus, in these alternative embodiment(s), the customer 310 corresponds to a single remote site 110(n), and no base site 115 need be involved in the current transaction.

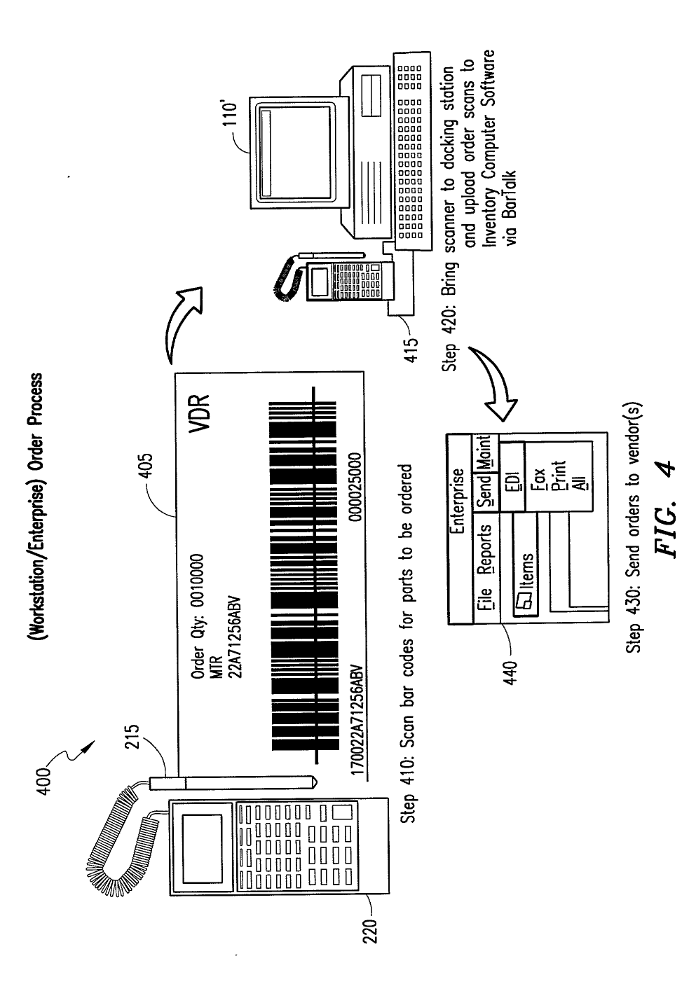

Referring now to FIG. 4, an exemplary order process in accordance with the present invention is illustrated generally at 400. The order process diagram 400 is applicable to point of use replenishment systems with a single inventory site as well as those with multiple inventory sites. At step 410, the bar code(s) 405 for part(s) to be ordered are scanned using the, e.g., bar code reader 215 of the handheld scanner 220 (or otherwise entered into an, e.g., portable inventory information input device) At step 420, the handheld scanner 220 is brought to a docking station 415 of (or in sufficient proximity to otherwise permit communication to (e.g., using an RF scanner)) an inventory computer 110′. The order scans/information are uploaded to inventory computer software via BarTalk.

At step 430 of the exemplary order process 400, the order(s) are sent to one or more vendor(s) using, e.g., the inventory software 440 via a jointly-accessible network such as the Internet 105 (of FIG. 1). The inventory software 440 may be realized using a relatively-thin client such as browser, including a browser modified by a customized skin with a personalized appearance and a specialized set of menus. It should be noted that the inventory software 440 may alternatively send (or be explicitly required to send) the order(s) to a base site 115. When the ordered product arrives with its own bar coding, the ordered product is scanned into the system (e.g., possibly precipitating the creation of a paper or electronic receipt for tracking of product and/or vendor, for receipt confirmation, etc.) to become incorporated into the current inventory and added to the current inventory level.

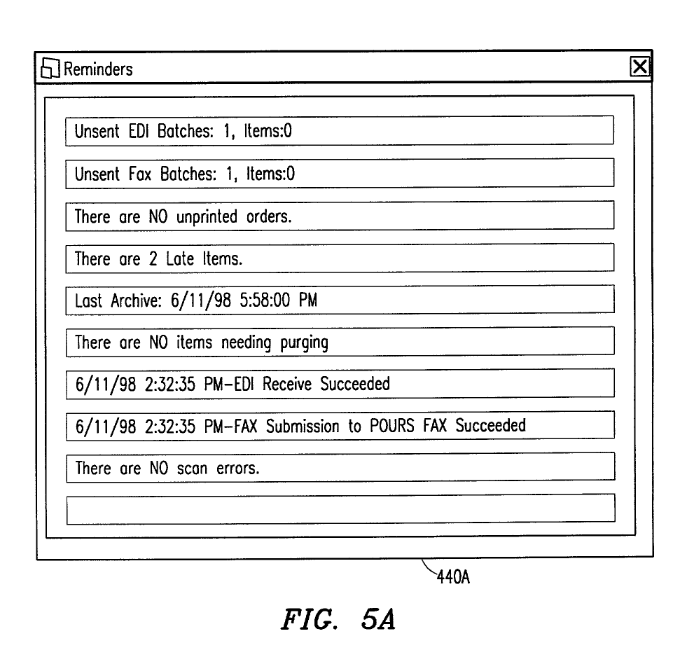

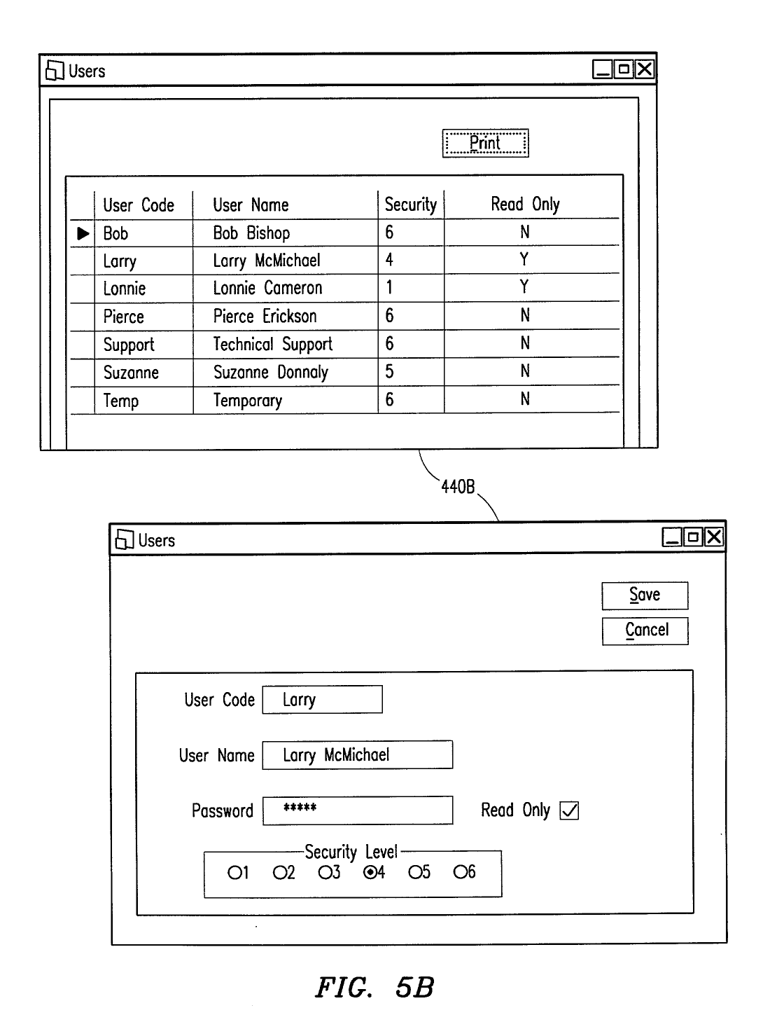

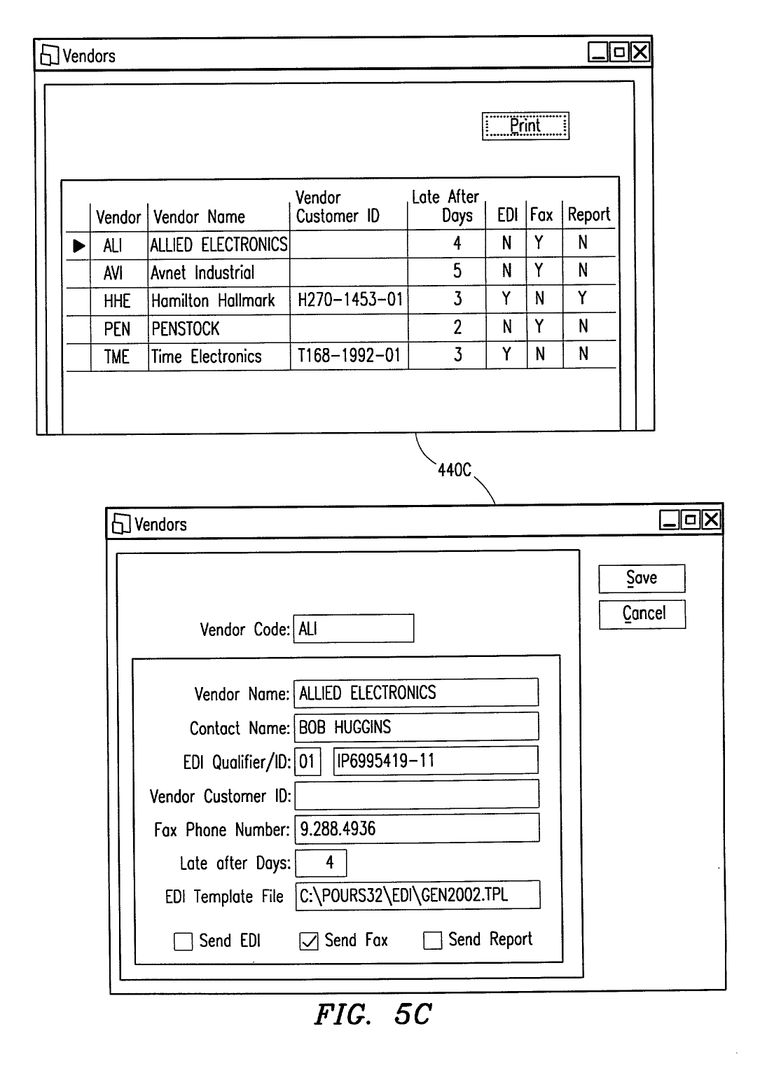

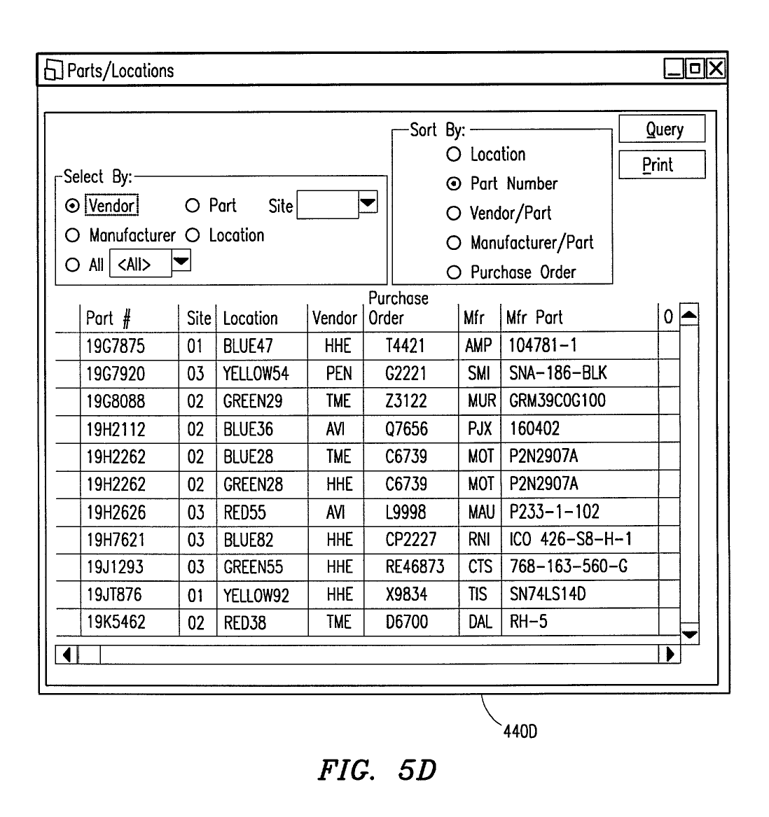

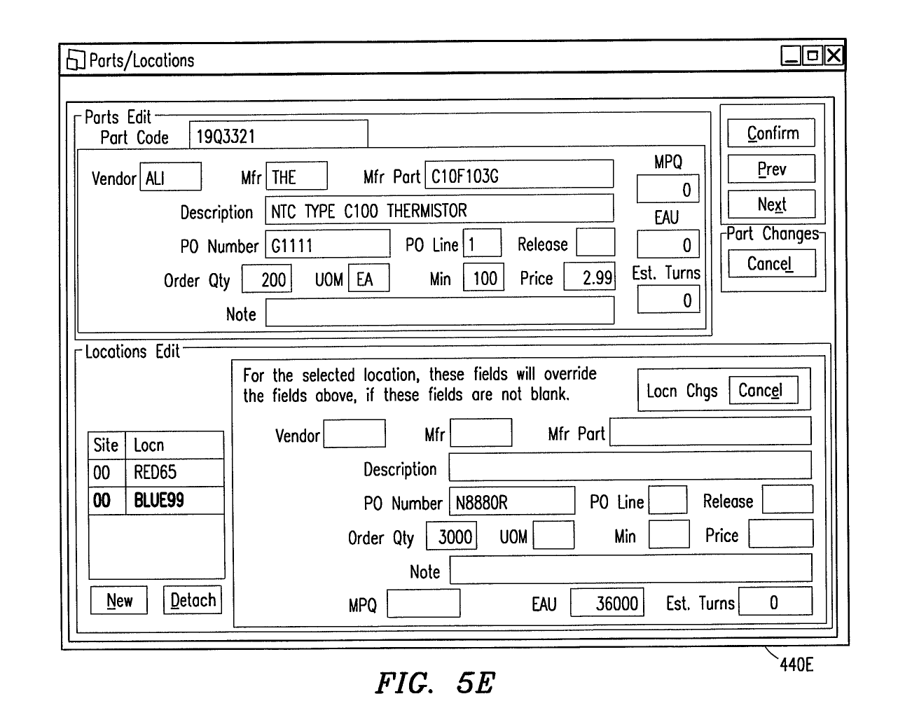

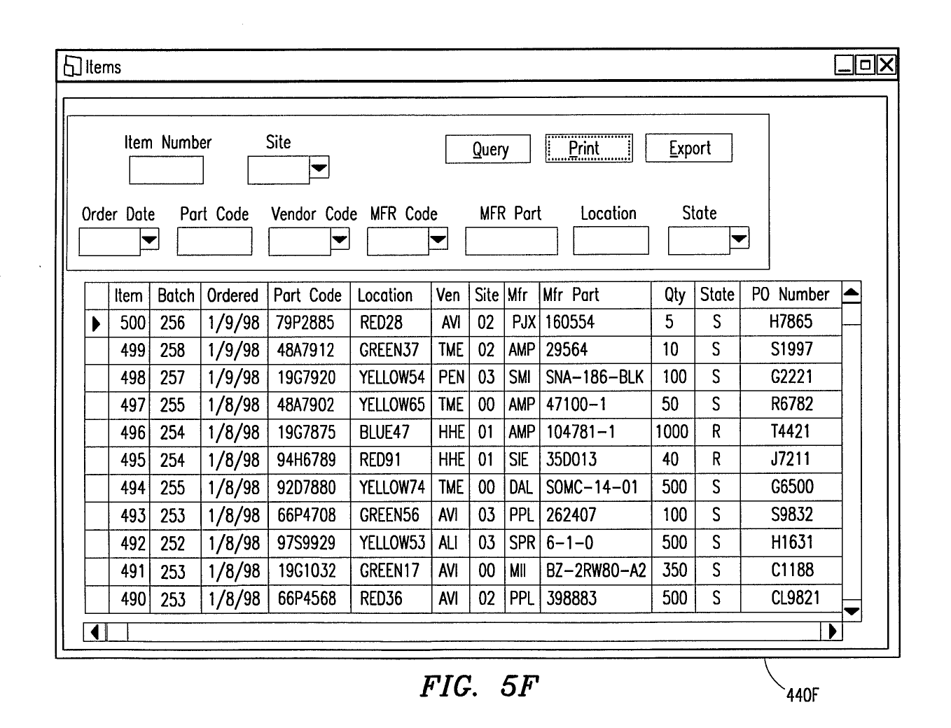

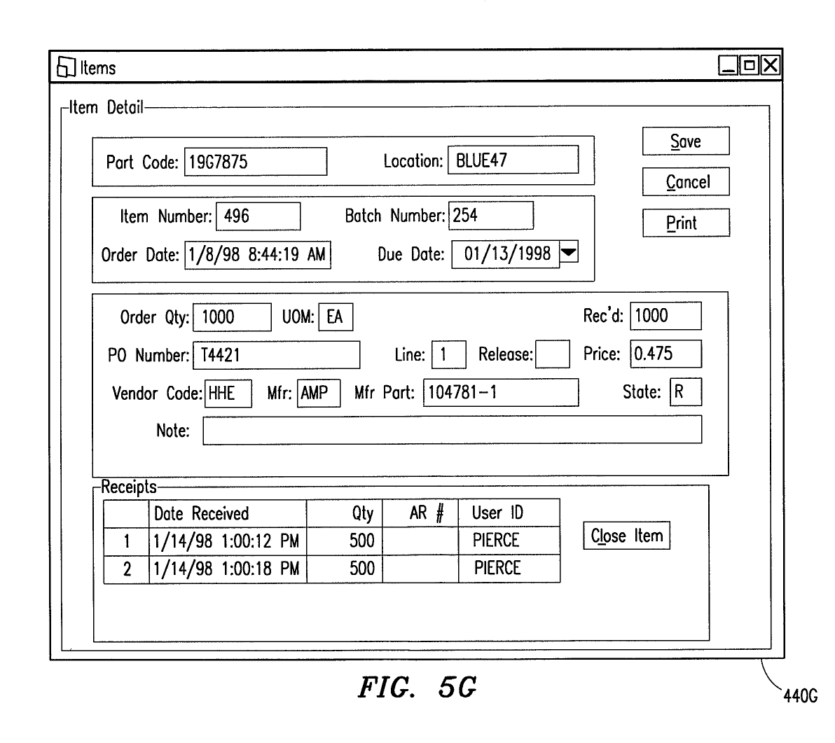

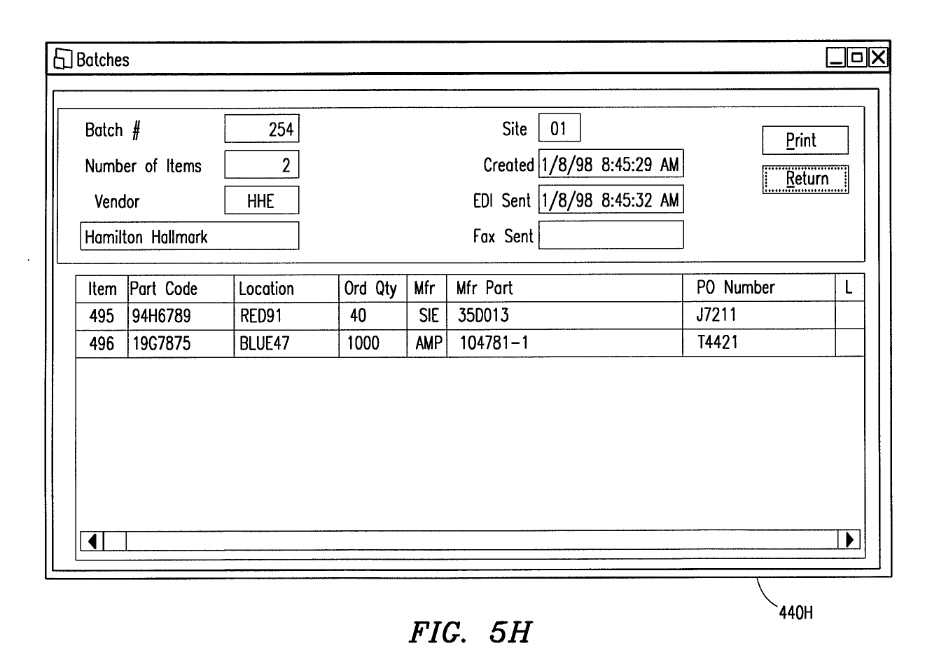

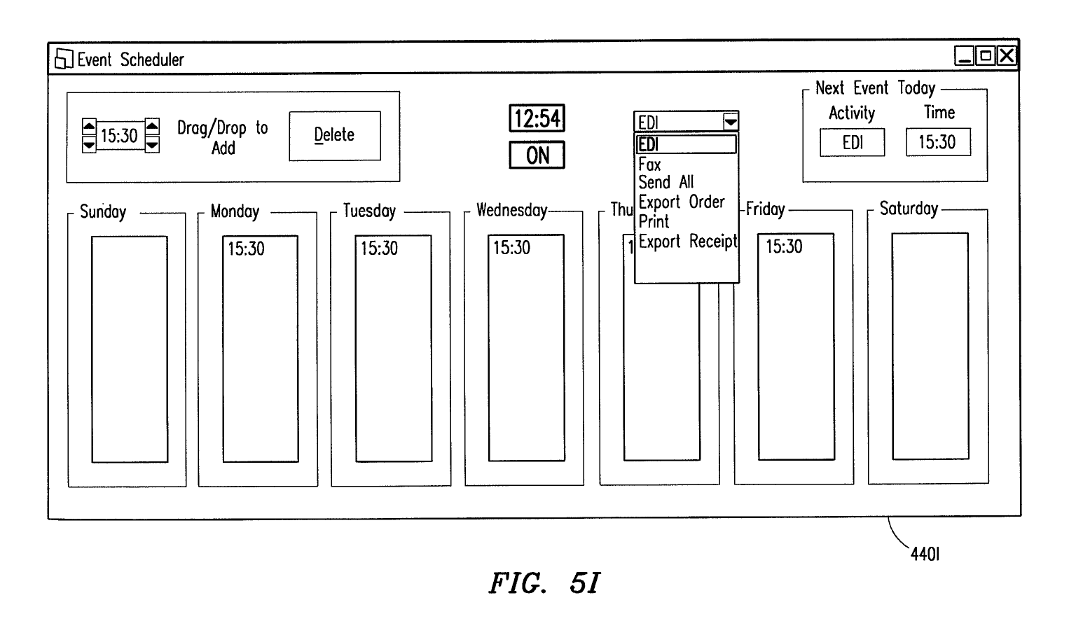

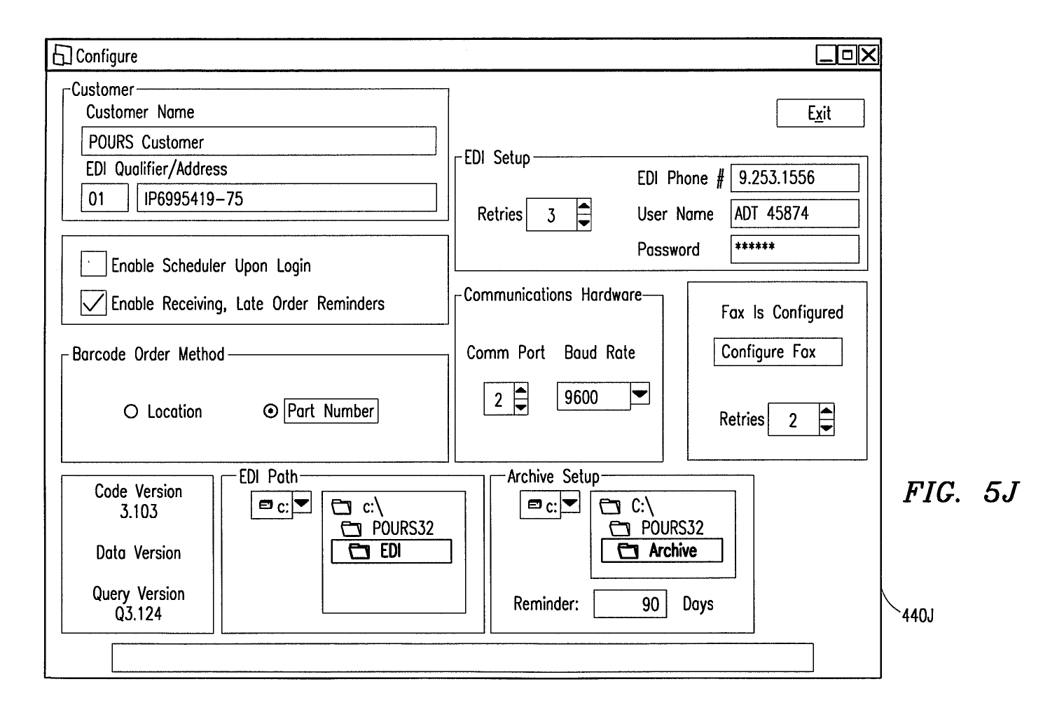

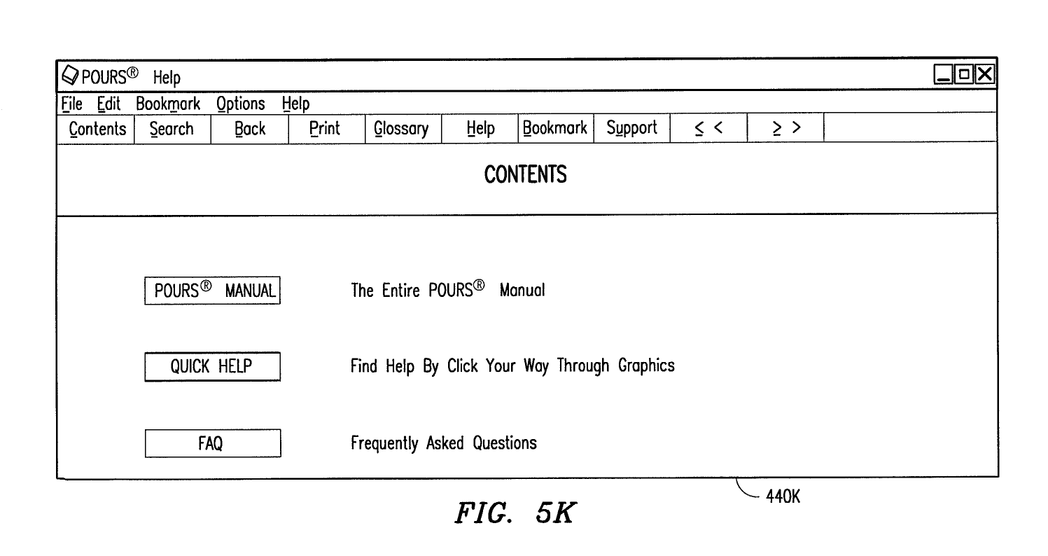

Referring now to FIGS. 5A-5K, exemplary aspects of exemplary inventory software in accordance with the present invention are illustrated generally at 440A-440K. Exemplary inventory software screen (or portion thereof) 440A (of FIG. 5A) provides a quick overview of system status and appears at login and logout (e.g., to provide reminders). It identifies issues that require attention and confirms the last EDI and fax transmissions. In certain embodiment(s), clicking (e.g., double-clicking with a mouse or other input device) any box reveals additional details related thereto. Exemplary software screens 440B (of FIG. 5B) reflect the exemplary six (6) levels of security that may be instituted for users, as well as a login screen for entering a user-assigned identification (ID), a password, and the security level. For security levels 1-5, a read-only option is available. Notably, the user ID may be recorded in order and receipt audit trail.

Exemplary software screens 440C (of FIG. 5C) illustrate how the days late criteria for each vendor may be established and how multiple send methods for vendors are possible with the exemplary inventory software 440. Furthermore, a unique EDI map template may be set up for each vendor. In accordance with certain embodiment(s), different capabilities may be provided by different levels of the inventory software 440. For example, a standard level may only enable orders to be sent to the proprietor, an enhanced level may only enable EDI orders to the proprietor and faxed orders to any supplier, and a deluxe enhanced level may enable both EDI and fax orders to any vendor. Exemplary software screen 440D (of FIG. 5D) illustrates a listing of all part numbers and their location(s) for parts that have been set-up for replenishment; clicking any such part number activates an edit screen therefor. There is also a query feature that allows data to be selected and/or sorted for (i) editing and (ii) printing reports and labels. Exemplary software screen 440E (of FIG. 5E) illustrates a particular part's part number and location(s). It includes data required to place purchase orders, and allows multiple locations for each part/part number. “EAU” and “Estimated Turns” fields facilitate bin quantity management.

Exemplary software screen 440F (of FIG. 5F) illustrates a listing of all line items created with an exemplary point of use replenishment system in accordance with the present invention. A query feature enables a user to create ad hoc reports, and clicking any item activates a detailed screen for that particular item. Notably, the data is exportable to other systems and/or formats. Exemplary software screen 440G (of FIG. 5G) illustrates a detailed (e.g., historical) view of a particular item. A receipts audit trail includes date/time, quantity, and user ID information. For unsent items, the order quantity, the purchase order number (PO#), and note fields are editable. Exemplary software screen 440H (of FIG. 5H) illustrates a detailed view of a particular batch, with each item of the particular batch being listed. With respect to “batches”, items are batched by vendor. The detailed view shows date/time when batches were sent to the destination vendor and date/time when EDI 997 confirmation was received.

Exemplary software screen 440I (of FIG. 5I) illustrates a scheduler for an exemplary point of use replenishment system in accordance with the present invention. It can illustrate order sends, including EDI, fax, print, or all. It enables the exportation of information/data/files, and it enables access to back-up routines for batch files. The inventory software 440 may be configured to start upon login (e.g., it may be the “home page” of browser-type software if login is required before starting the browser). Notably, the scheduler may remain active after logout (e.g., to receive order confirmations over the Internet 105, pull information from a base site 115, etc.). Exemplary software screen 440J (of FIG. 5J) illustrates an exemplary system configuration screen, which is accessible by only higher level users (e.g., level six (6)). It enables EDI and fax set-up. The user may also (i) control the database version and (ii) establish path and reminders for archiving. Furthermore, the Transmission Control Protocol/Internet Protocol (TCP/IP) may be established along with browser-level security measures, such as encryption and the ability to accept data/programs from and/or “turn-over” control to an external computer.

Exemplary software screen 440K (of FIG. 5K) illustrates a “Help” contents menu. For example, a user is provided access to one or more manuals in text form, to graphics with clickable zones for selecting help areas, and to frequently asked questions (FAQs). The ability to search for a specific help topic is also provided. The actual data and/or search engine may be located on the users local hard drive and/or fully or partially on a distant computer that is accessible by the user from the local inventory computer 110′ (of FIG. 2) via the Internet 105 (of FIG. 1).

Inventory software 440 in accordance with certain embodiment(s) of the present invention provide the ability to create numerous reports. These reports include:

inventory turns reports (e.g., by vendor or part number);

one-time delivery reports (e.g., by vendor or location);

daily order summary;

daily receipt summary;

order book (e.g., including bar codes to create orders);

usage report (e.g., weekly usage by part number);

open items reports (e.g., including bar codes for receiving);

late items report;

order history (e.g., by part number);

bar code labels (e.g., multiple formats);

purchase order detail; and

custom queries and ad hoc reports.

The data and software to create these reports, or a subset thereof, may be located on the local inventory computer 110′, a centralized computer (e.g., at a base site 115, at a proprietary site 140), distributed across several computer sites, or a combination thereof. In embodiment(s) in which the data and/or software is primarily or entirely located at a centralized computer, the interface for creating such reports may be a browser-type software package in which the report are created (e.g., in hyper-text markup and linking (HTML) format) at the centralized computer and merely displayed (and possibly stored) at the local computer.

With an exemplary point of use replenishment system in accordance with the present invention, the bar code 405 (of FIG. 4) may be considered the “lowest”, most decentralized aspect. With a bar code attached to a portion of inventory 210A/B (e.g., a kanban-sized portion), an individual on the production line 205 (of FIG. 2) may initiate an order for the inventory replenishment process using a “pull” type mechanism with the handheld scanner 220 by scanning an empty bin. When the order information is sent to a centralized site (e.g. by connecting the handheld scanner 220 to an inventory computer 110′ having communication ability (e.g., modem, network card, etc. using phone lines, the Internet, etc.)), the centralized site can manage the replenishment for multiple remote sites 110 (of FIG. 1). This enables economies of scale and coordination while reducing materials acquisition infrastructure (including personnel) required at the remote sites 110. The inventory management at the centralized location may approve and consolidate orders before sending them to vendors 125, 130, 135 (e.g., from the centralized location).

The management may therefore review all orders before they are sent to vendors. Furthermore, a history of all purchasing may be maintained at one convenient central location. Advantageously, the product may be shipped directly to the remote site 110 that initiated the order by scanning the empty bin. When the product arrives and/or when the bin is re-filled with the product, a receipt may be scanned at the remote site (along with the bar code of the product to enter it into the inventory system if separate). This may ensure that the proper stock reservation levels, as optionally established in the inventory software 440, are maintained.

As described hereinabove as alternative embodiment(s) with reference to FIGS. 1-4, the remote sites 110(n) may send orders directly to the vendors as needed. The ordering and inventory levels at the various remote sites 110(n) may be periodically reconciled electronically and automatically (e.g., using the inventory software 440 over the Internet 105). However, as explained above (at least partially in the preceding paragraphs) having a centralized repository offers multiple benefits. The centralized repository of inventory information, including orders requested, orders sent and pending, transactional history, etc., may be located at several possible positions, including being somewhat distributed. One location that was alluded to hereinabove is the base site 115 (of FIG. 1) for the corporation's inventory management and control. An alternative is the proprietary site 140, which is illustrated in FIG. 1 as being connected to the Internet 105 and a fax vendor 135 (over a telephone connection). Having the inventory information of the corporation at a proprietary site 140 offers numerous advantages, including but not limited to that the data warehousing and/or information management is effectively at least partially outsourced. Furthermore, using a WWW-type environment enables a relatively-thin client to be utilized at the remote sites 110(n), including a base site 115 which may still be co-located with centralized inventory managers while the inventory information is co-located at the proprietary site 140. The proprietary site 140 may also enable a closer integration with the VAN 120 and/or the proprietary distribution centers 305 (from FIG. 3A). It should be noted that the proprietary site 140 may be integrated with, or even part of, the VAN 120.

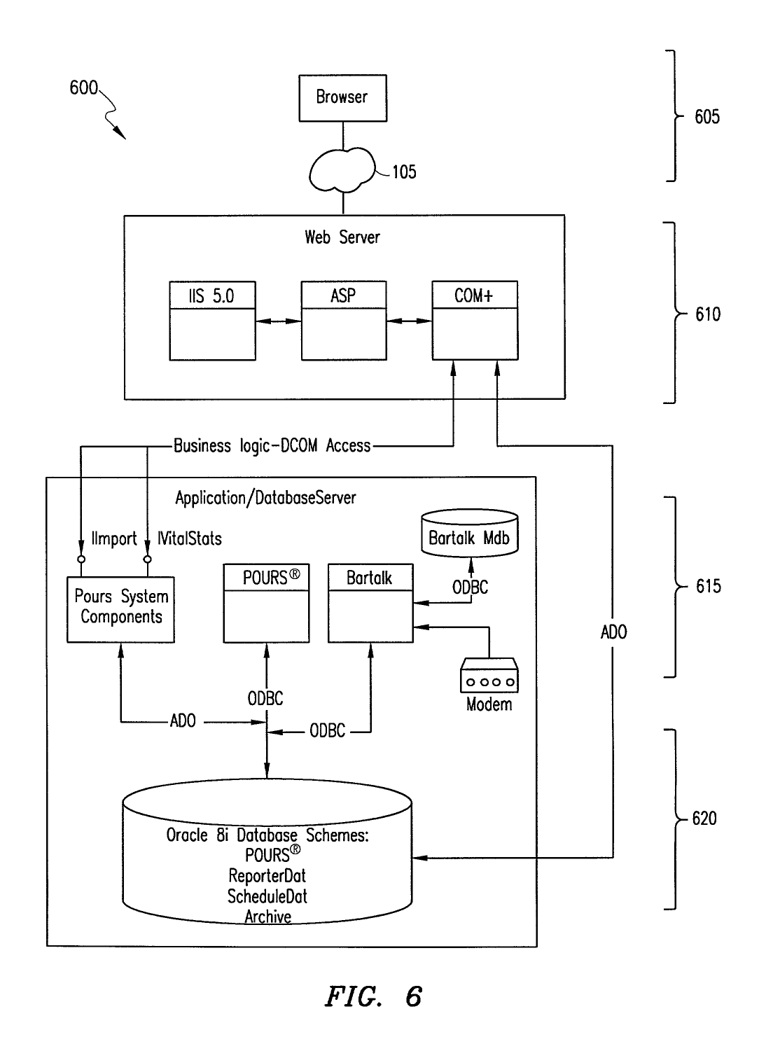

Referring now to FIG. 6, a portion of an exemplary point of use replenishment system in which at least part thereof is realized using a web-based scheme in accordance with the present invention is illustrated generally at 600. The portion 600 may, at least in part, enable customers of the proprietor to to view their orders, receipts, parts and other data from the proprietor's web site (e.g.,using a browser). They are also able to update their scanned orders and receipts that are in error, generate bar code labels, and view/print reports. For these exemplary embodiment(s), at the user's site, orders and receipts are scanned and stored on a scanner. The stored scans are then transmitted to the proprietor's server and imported into a database. The “POURS” module schedules the creation of the new orders and receipts and sends them via EDI to their respective suppliers via a TCP socket connection to the proprietor's server. The user can view these new orders and receipts by browsing to the proprietor's web site and logging in to its application. The web site provides customers with different views from a centralized database that enables them to monitor the status of their orders, and review exceptions such as scan errors, late orders, etc. The proprietor's support personnel may maintain the parts master list for each customer. Alternatively, customers may be empowered to change their parts master list over the WWW.

The web site may include the following exemplary screens:

(1) Home Page: Welcomes and orients the user. Allows the user to login to the system.

(2) To Do List Page: Displays the following counts and links:

Suspended Order Scan(s): Order scan errors page which allows the user to correct and import the order or delete it.

Suspended Receipt Scan(s): Receipt scan errors page which allows the user to correct and import the receipt or delete it.

Late Order(s): Late orders report is generated.

Unsent EDI Order(s): Unsent EDI orders report is generated.

Unsent Fax Order(s): Unsent Faxed orders report is generated.

Unprinted Order(s): Unsent printed orders report is generated.

Failed to send EDI: Failed EDI orders report is generated.

Failed to send Fax: Failed Fax orders report is generated.

Failed to Print: Failed print orders report is generated.

The reports may be generated using a reporting software and viewed using, for example, an ActiveX control or Java applet, depending on the browser type.

(3) Orders Page: Displays orders for current customer. Includes search to display orders by date range, part number, manufacturer part number, PO#, location, etc.

(4) Receipts Page: Displays a list of the selected customer's receipts. Includes search to display orders by date range, part number, manufacturer part number, PO#, location, etc.

(5) Locations Page: Lists location and part information for current customer. Includes search to display orders by part number, manufacturer part number, PO#, location, etc. Labels can be generated from this view by checking the desired location/part and running “generate label”.

(6) Parts Page: List of parts and associated manufacturer and supplier for a selected customer. Includes search to display orders by part number, manufacturer part number, PO#, location, etc.

(7) Support Page: Gives general information on application support including detailed information on scanners configured for use with the application.

The above views may be one-page HTML reports completely extracted from the centralized database with no drill-down capability. Also, from any page, the user can hit the proprietor's email address to send it e-mail.

An exemplary system architecture may be thought of as a four tiered system: Tier 1 (605): Browser; Tier 2 (610): IIS 5.0 Web server ASP pages, and COM+; Tier 3 (615): Pours, Bartalk, Modem ports, DCOM Pours Objects; and Tier 4 (620): Database Server.

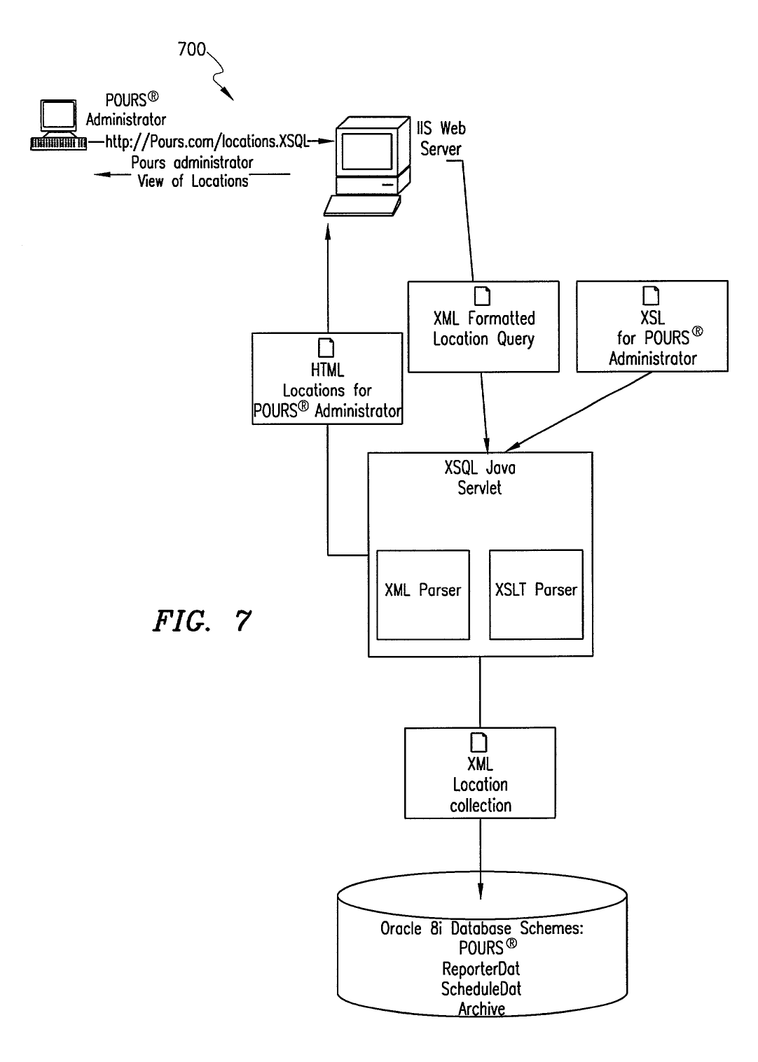

Referring now to FIG. 7, another portion of an exemplary point of use replenishment system in which at least part thereof is realized using a web-based scheme in accordance with the present invention is illustrated generally at 700. And referring now to FIG. 8, yet another portion of an exemplary point of use replenishment system in which at least part thereof is realized using a web-based scheme in accordance with the present invention is illustrated generally at 800. The portions 700 and 800 illustrate functionality to, inter alia, maintain the parts master. This functionality includes adding, updating, and deleting customer parts, locations, manufacturer parts, PO#s, and suppliers. Customers can include customers of the proprietor as well as external companies. Roles can be setup for users that determine what functionality they determine as beneficial and usable to them (e.g., Administrator, Sales, Line Personnel, etc.). In certain embodiment(s), suppliers, manufacturers, manufacturer parts, and purchase orders are established and/or available system-wide, and they are not restricted to specific customer(s).

Referring now to FIG. 9, an exemplary point of use replenishment system in which at least part thereof is realized using the Internet in accordance with the present invention is illustrated generally at 900. In a first step, when stock is depleted (e.g., a bin is emptied), the customer scans (e.g., a bar code 405) the empty bin(s) with a portable input device such as a portable bar code reader (PBR) (e.g., a handheld scanner 220). The scanned information is transmitted (e.g., by modem) to a proprietary server and database at the proprietary site 140. It should be noted that the transmission device may be as simple as a modem 110′ that merely dials over telephone lines to a modem at the proprietary server 140. Alternatively, the local inventory computer may be more substantial than a scanner/docking bay/modem combination and may be composed of a PC or similar. In this alternative, the PC-based inventory computer 110′ may communicate with the proprietary server over the Internet 105 via, for example, a point-of-presence (POP) for the proprietary site 140. It should be understood that the dashed elements of FIG. 9 indicate alternative embodiment(s), and any such combination is embraced by the present invention.

In a second step, purchase orders 230 (e.g., using B2B Application to Application schemes) may be transmitted to the supplier's business application (e.g., over telephone lines by modem, via the Internet 105, etc.). The supplier confirms the order and ships the product to the customer's point of use. Thus, the inventory is shipped via the, e.g., third party shipment 225 to the customer's facility. It should be noted that the first and third steps may therefore occur at the same physical remote site 110(n). It should also be noted that, in real-time, the first through fourth steps may not occur in any particular order. For example, aspect(s) of the fourth step may be effectuated such that the order scans are “intercepted” and the purchase order is modified or never sent to that or any supplier.

Continuing with the third step, the customer scans the receipt with the PBR, and the scans may be transmitted to the proprietary server, e.g., by modem alone over telephone lines, over the Internet 105 instead, etc. With the fourth step, the customer uses inventory software 440 (e.g., a browser) to log into the server over the Internet 105. The inventory computer 110′ can be located at, for example, a base site 115 that is ultimately responsible for maintaining control and organization over the inventory management throughout the company. The user can, for example, verify contract information, check order status, print reports, correct scan errors, print bar code labels, etc.

In certain embodiment(s), initial implementation may entail one or more of the following steps: (1) A list of customer part numbers with associated contract information is provided (e.g., in a pre-formatted Excel spreadsheet, through the browser, etc.) (The list may include part number, location, PO#, price, standard order quantity, supplier, etc.); (2) The information is imported into the database; (3) The customer is provided with a PBR, a modem, and a user ID/password to log into the proprietor's web site (Complementary software may be installed in the PBR's flash memory. This software may provide a menu-driven user interface that prompts the user for order and receipt scans. It may allow the user to review scans before they are transmitted to the web server. It may also include the communications software that is used to connect with and transmit to the server.); (4) Customer logs into web site to verify contract information is correctly associated with parts information; (5) Customer prints bar code labels from web site and labels inventory bin boxes. And on a daily or other frequent/recurring basis, as inventory bins are emptied, the attached bar code label may be scanned. Then, receipts are scanned as product is received from suppliers to replenish the inventory bins. Once a day, for example, the scanner may be returned to its docking station, which is connected to a modem. The user presses the scanner's transmit button, which initiates the process of connecting and transmitting all scans to the server. The server (e.g., software thereof) processes the customer's scans. Orders are then transmitted to the contracted supplier, and receipts are used to close existing orders. Meanwhile, the customer may log into the web site to review online and/or print reports of: Order Status, Late Orders, Scan Errors, Order History, Receipts, etc.

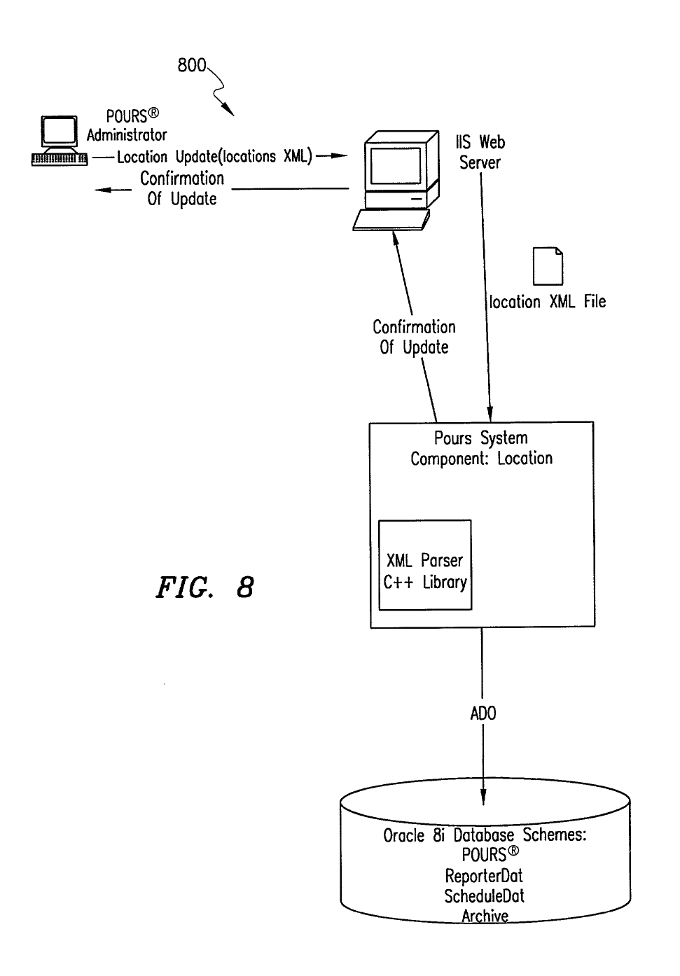

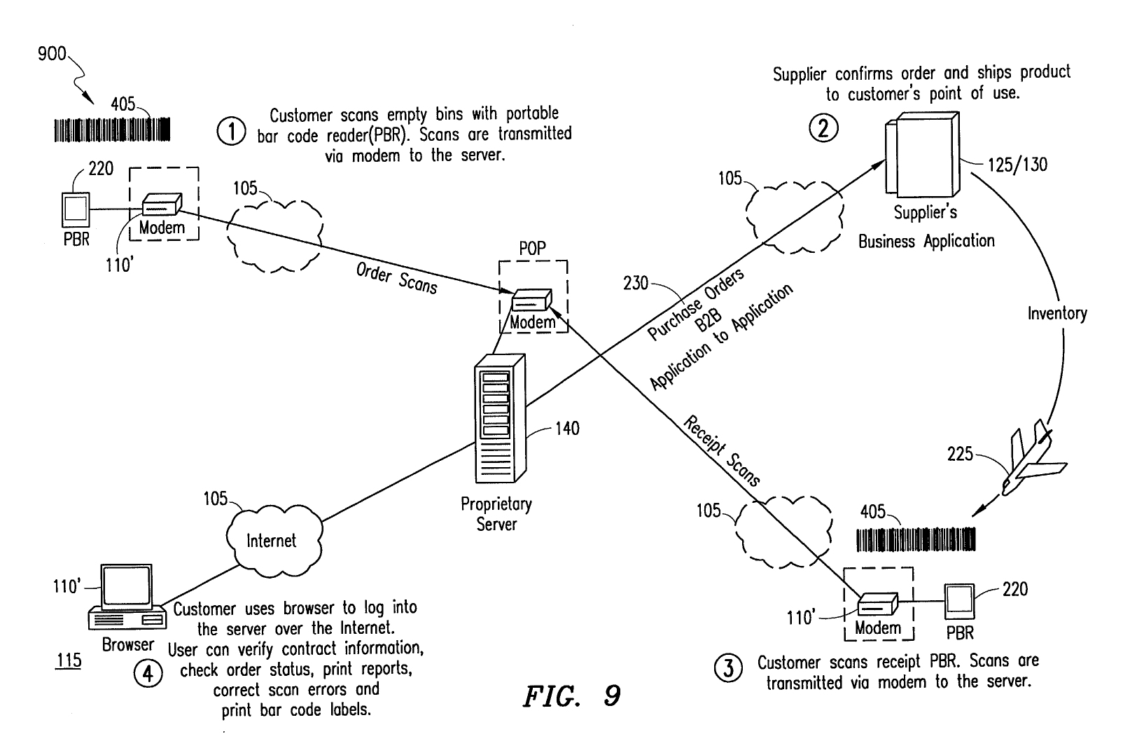

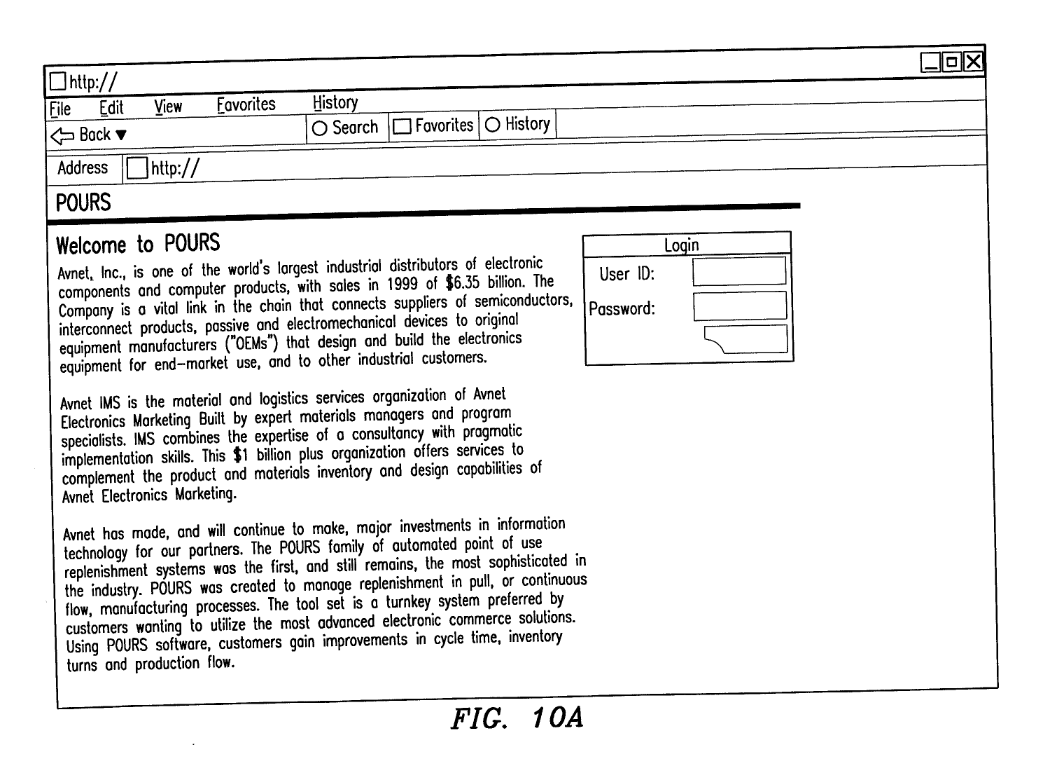

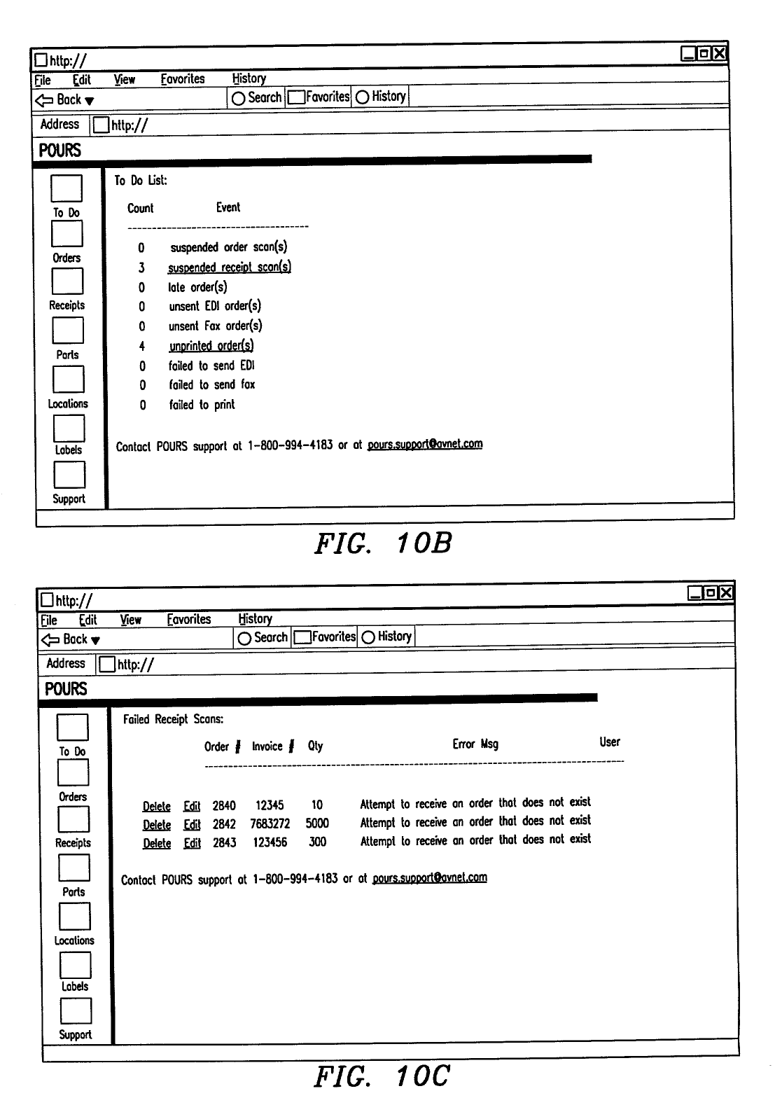

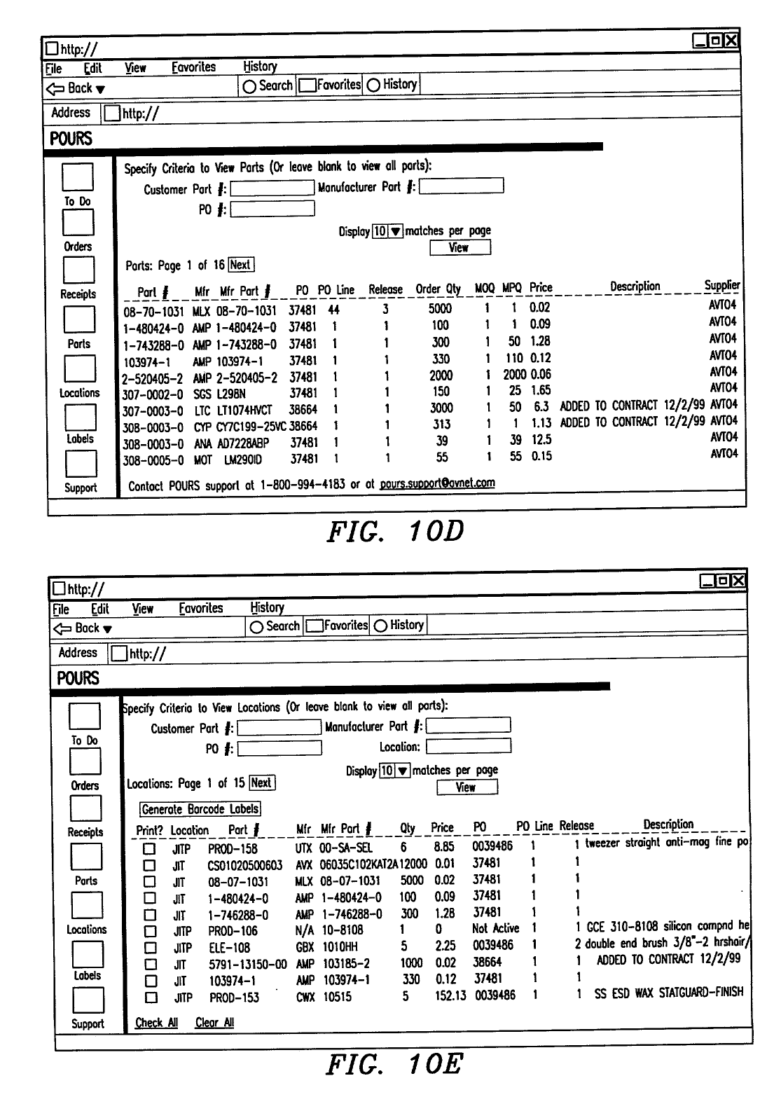

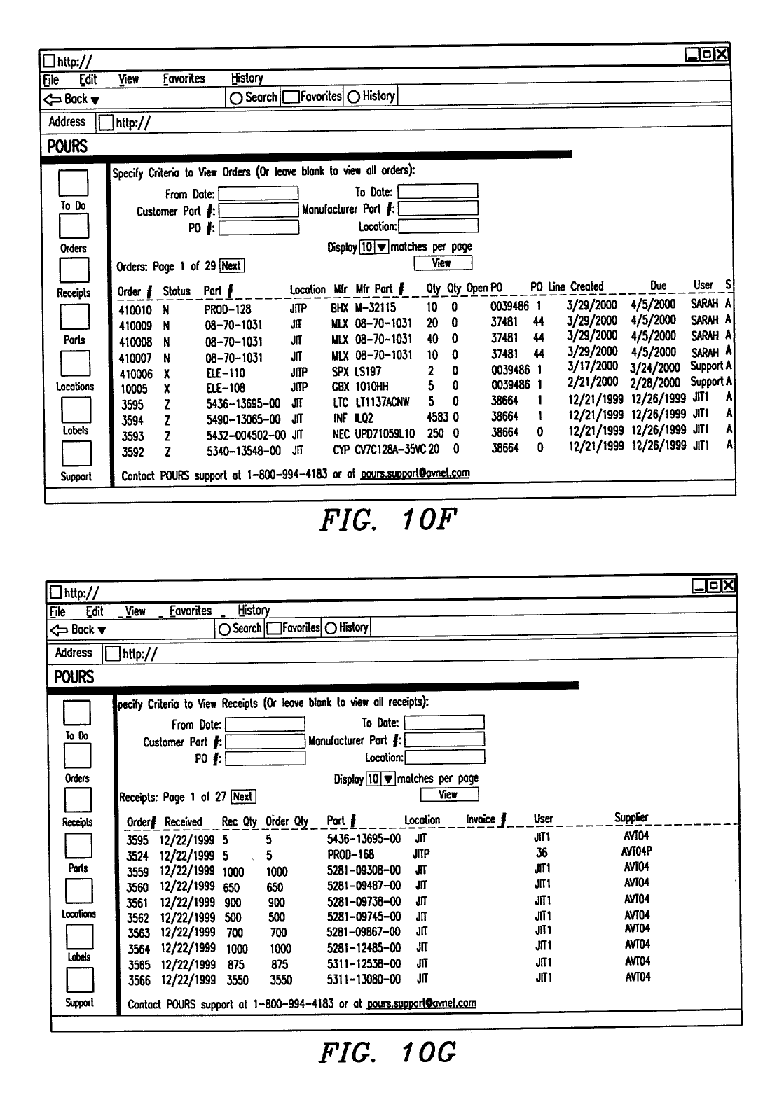

Referring now to FIGS. 10A-10G, additional exemplary aspects of exemplary inventory software in accordance with the present invention are illustrated generally at 440A′-440G′. Exemplary software screen 440A′ (of FIG. 10A) illustrates a login screen that requires users to login into the server to gain access to the database. Each user has access only to data associated with their user ID. Exemplary software screen 440B′ (of FIG. 10B) illustrates a “to do” list that provides a quick overview of the respective inventory situation/system. Any details that may require attention can be summarized on such a screen. Each entry, especially those requiring attention, may be linked to further details regarding that entry. Exemplary software screen 440C′ (of FIG. 10C) illustrates a detailed screen that was linked to from a “to do” list. This exemplary detail screen lists failed receipt scans and enables the user to make corrections and submit the scan data online.

Exemplary software screen 440D′ (of FIG. 10D) illustrates a parts screen that allows a user to view and review their parts number list and any contract information associated therewith. For example, the user is empowered, on this and/or a different screen, to assign a supplier for each part, so contract information for that supplier may be accessible by a link from this parts number list screen. The parts list can be filtered by, for example, customer part number, manufacturer part number, purchase order number, etc. Exemplary software screen 440E′ (of FIG. 10E) illustrates a location screen that indicates what parts are available or otherwise present at which locations. In other words, the user may manage parts by location. The location information may be filtered by customer part number, manufacturer part number, purchase order number, location, etc. Additionally, bar code labels may be printed from this screen.

Exemplary software screen 440F′ (of FIG. 10F) illustrates an orders screen that can display a history of orders placed through a point of use replenishment system in accordance with certain embodiment(s) of the present invention. The user can review details, including order status, order quantity, open quantity, order date, due date, user who placed the order, associated contract information, etc. Records on this screen may be filtered by date, customer part number, manufacturer part number, purchase order number, location, etc. Exemplary software screen 440G′ (of FIG. 10G) illustrates a receipts screen that can display a history of receipts processed through the system. The user can review details, including receipt date, receipt quantity, invoice number, receiving user, contract information associated with the order for which the receipt was made, etc.

One or more, but not necessarily all, of the embodiment(s) described herein may include one or more of the following feature(s) and/or attributes, either alone or in combination:

With Regard to General Functionality

1. Min/Max Model—Allows user to specify Min/Max levels. System automatically reorders upon reaching Min.

2. Report Printer—User can specify different printers for different reports. Allows reports to be sent to specific departments or areas. (e.g., Open Orders report can be sent to LAN printer on receiving dock.)

3. Reports Configurable—User can specify parameters associated with each report, such as: report name, default printer, filters and screen from which it is accessible.

4. Tracks Actual Usage—System maintains usage data for each part number.

5. Unique Location Rules—User can specify if system should enforce unique Locations or allow duplication.

6. Part Number E/C Level—Allows duplicate part numbers where multiple engineering change levels exist.

7. Part Number Active/Inactive Flag—Specific part numbers can be flagged as inactive, preventing additional orders while in this state.

8. Receive inbound EDI documents without sending—Allows system to connect to VAN and receive inbound EDI documents even if there are no documents to send.

9. Custom Order Numbering—Allows customer to define sequential order number's starting position.

10. Backorder Rules—User determines whether to process backorders or suspend them as errors.

11. License Code—Requires active license code to run software. Allows support team to monitor active users.

With Regard to the Interface

1. Custom User Layouts—User can define and save individual layout preferences for each screen. Column arrangements, sort order and filter criteria preferences are stored for each user and automatically loaded as user logs in.

2. User Set-up Wizard—Step-by-step wizard interface for adding new users.

3. Supplier Set-up Wizard—Step-by-step wizard interface for adding new users.

4. Tool Bar—Graphical tool bar interface for common functionality.

5. Right Click—Common functionality available with right mouse clicks.

6. Sort/Filter/Find—Allows user to sort data in ascending or descending order and/or define specific filter criteria to generate adhoc reports. Standard Windows Find functionality is offered.

With Regard to User Security

1. Predefined User Type Profiles—Simplifies user set-up process by providing templates of common user types.

2. Clone Existing User—Simplifies user set-up process by allowing administrator to clone existing users.

3. User Managed Passwords—Each user can specify and maintain their own password.

4. Function Specific Control—Administrator can assign very specific rights to each user based on their responsibility and authorization.

With Regard to Suppliers

1. Approved Vendor List (AVL)—A list of approved substitute part numbers can be associated with each customer part number.

2. Split Vendor List—The AVL (above) can specify percentage splits for each approved part number.

3. Receiving On/Off—Receiving can be configured differently for each supplier.

4. Minimum Package Quantity (MPQ) Rules—Defines how orders are processed when they do not meet the specified.

5. Minimum Order Quantity (MOQ) Rules—Defines how orders are processed when they do not meet the specified MOQ.

6. Receipt Rules—Defines how receipts are processed when they do not meet the open order quantity.

With Regard to Orders

1. Order by PN Only—Allows orders to be created for part numbers without specifying location.

2. Order by Location Only—Allows orders to be created for locations without specifying a part number.

3. Order Approval Rules—Defines orders that will require approval before transmission to a supplier. Approval can be required for specific part numbers or when order quantity or value exceed a specified limit.

4. Purchase Order Rules—Allows user to specify expiration date or quantity limit for specific purchase orders. Also increments release number for each PO generated.

5. EDI via File—EDI can be mapped to a specific file and system path for internal processing.

6. *EDI via ECG—EDI can be sent directly to proprietor using the E.C. Gateway.

7. *EDI via Email—EDI can be transmitted to supplier as an email attachment.

8. *EDI via FTP—EDI can be transmitted to a supplier's FTP server.

9. *RosettaNet PIP—orders, ship notices, etc.

With Regard to Transmission Log

1. Identifies ILOG Number—Transmission log tracks ILOG number from EDI sends for troubleshooting or follow-up.

2. Displays Status—Transmission log shows send status and error messages if applicable.

With Regard to Scheduler

1. Print Reports—Reports can be scheduled to print routinely.

2. Fax Reports—Reports can be scheduled to fax routinely.

3. Import Scans—Process of importing scans can be scheduled to occur at regular intervals.

4. Archive—Database archive process can be scheduled routinely.

5. Timing Options—Events can be scheduled “At System Start-up”, Daily, Weekly, Monthly, at specific “Intervals” or “Once” at a specified time/date.

Although preferred embodiment(s) of the methods, systems, and arrangements of the present invention have been illustrated in the accompanying Drawings and described in the foregoing Detailed Description, it will be understood that the present invention is not limited to the embodiment(s) disclosed, but is capable of numerous rearrangements, modifications, and substitutions without departing from the spirit and scope of the present invention as set forth and defined by the following claims.

What is claimed is:

1. A method for facilitating inventory management and/or control, comprising the steps of:
inputting, at a first location, information associated with at least one stock;
transmitting the information associated with at least one stock to a database;
sending a purchase order from the database to a supplier responsive to the information associated with at least one stock; and
monitoring, from a second location, the information associated with at least one stock and the purchase order.

2. The method according to claim 1, wherein said step of inputting comprises the step of inputting the information into a handheld electronic device.

3. The method according to claim 2, wherein said step of inputting the information into a handheld electronic device comprises at least one of the step of (i) scanning the information, the handheld electronic device comprising a handheld scanner, and (ii) detecting a radio frequency signal, the handheld electronic device comprising a radio frequency receiver.

4. The method according to claim 1, wherein the information associated with at least one stock comprises a bar code.

5. The method according to claim 1, wherein the at least one stock comprises a pre-established kanban unit.

6. The method according to claim 1, wherein said step of transmitting the information associated with at least one stock to a database comprises at least one of the steps of (i) transmitting the information via a modem over a telephone line and (ii) transmitting the information over an internet.

7. The method according to claim 1, wherein the database comprises a plurality of segments, each segment corresponding to a different customer's inventory.

8. The method according to claim 1, wherein said step of sending a purchase order from the database to a supplier responsive to the information associated with at least one stock comprises the step of sending the purchase order over an internet to the supplier.

9. The method according to claim 1, wherein the purchase order comprises an electronic data interchange (EDI) format communication.

10. The method according to claim 1, wherein said step of monitoring, from a second location, the information associated with at least one stock and the purchase order comprises at least one of the steps of (i) viewing a part number related to the information associated with at least one stock, (ii) viewing a history of transactions related to the supplier, and (iii) viewing a screen that lists a plurality of stock of the first location.

11. The method according to claim 1, wherein said step of monitoring, from a second location, the information associated with at least one stock and the purchase order comprises the step of monitoring using a relatively thin client with communications being transmitted over an internet.

12. The method according to claim 11, wherein the relatively thin client comprises a world wide web (WWW) browser.

13. The method according to claim 1, further comprising the steps of:
sending a shipment including the at least one stock to the first location; and
entering information associated with a receipt that corresponds to the shipment.

14. A method for facilitating inventory management and/or control, comprising the steps of:
establishing a first set of parameters, from a first location, for an inventory situation of a first customer using thin-client software;
entering into a database, from the first location, inventory information for the inventory situation of the first customer using the thin-client software; and
accessing, from the first location, the inventory situation of the first customer using the thin-client software.

15. The method of claim 14, further comprising the steps of:
establishing a second set of parameters, from a second location, for an inventory situation of a second customer using the thin-client software;
entering into the database, from the second location, inventory information for the inventory situation of the second customer using the thin-client software; and
accessing, from the second location, the inventory situation of the second customer using the thin-client software.

16. The method of claim 14, wherein said step of entering into a database, from the first location, inventory information for the inventory situation of the first customer using the thin-client software comprises the step of inputting information linking a plurality of parts to one or more suppliers.

17. The method of claim 14, wherein said step of establishing a first set of parameters, from a first location, for an inventory situation of a first customer using thin-client software comprises the step of inputting information specifying a plurality of remote locations.

18. The method of claim 17, further comprising the step of:
entering into the database, from a remote location of the plurality of remote locations, inventory information specifying at least a portion of the inventory at the remote location.

19. The method of claim 18, wherein said step of entering into the database, from a remote location of the plurality of remote locations, inventory information specifying at least a portion of the inventory at the remote location comprises the step of entering into the database the inventory information using a handheld input device.

20. The method of claim 14, further comprising the step of:
entering into the database, from a remote location, inventory information specifying at least a portion of the inventory at the remote location; and
wherein said step of accessing, from the first location, the inventory situation of the first customer using the thin-client software comprises the step of reviewing the at least a portion of the inventory at the remote location.

21. The method of claim 14, further comprising the step of:
entering into the database, from a remote location, inventory information corresponding to a stock order; and
wherein said step of accessing, from the first location, the inventory situation of the first customer using the thin-client software comprises the step of modifying the stock order.

22. The method of claim 21, wherein said step of accessing further comprises the step of accessing via an internet, and the thin-client software comprises a browser.

23. The method of claim 22, wherein the database is not located at either the first location or the remote location.

24. An arrangement for facilitating inventory management and/or control, comprising:
a database, said database including:
a first segment, said first segment corresponding to an inventory situation of a first customer;
a second segment, said second segment corresponding to an inventory situation of a second customer; and
a server, said server in operable communication with said database, said server adapted to provide access to the first segment for the first customer and to the second segment for the second customer by responding to requests from first and second thin-client software, respectively, the requests received and responded to via an internet.

25. The arrangement according to claim 24, wherein the responses are sent in hypertext markup language (HTML) format from the server.

26. The arrangement according to claim 24, wherein the requests comprises requests for reports directed to at least one of suspended order scans, suspended receipt scans, late orders, and unsent orders.

27. The arrangement according to claim 24, wherein said server is further adapted to receive at least one order from a remote site and send a purchase order to a supplier.

28. A method for facilitating inventory management and/or control, comprising the steps of:
receiving an order for stock from a remote site;
preparing a purchase order for the stock responsive to the order for stock received in said step of receiving;
sending the purchase order for the stock to a supplier, the supplier linked to a customer corresponding to the remote site and the stock;
updating an inventory situation associated with the customer responsive to at least one of the order for stock and the purchase order;
receiving an inquiry from browsing software via an internet, the inquiry regarding the inventory situation;
processing the inquiry to produce an inquiry response based on the inquiry and the inventory situation; and
sending the inquiry response over the internet in a format presentable by the browsing software.

29. The method according to claim 28, wherein the inquiry response format includes at least one link that effectively enables submission of a new inquiry.

30. A system for facilitating inventory management and/or control, comprising:
means for inputting, at a first location, information associated with at least one stock;
means for transmitting the information associated with at least one stock to a database;
means for sending a purchase order from the database to a supplier responsive to the information associated with at least one stock and other information stored within the database; and
means for monitoring, from a second location, the information associated with at least one stock and the purchase order.
